(19) United States
(12) Patent Application Publication
(10) Pub. No.: US 2016/0053667 A1
(43) Pub. Date: Feb. 25, 2016

(54) PRECHAMBER ASSEMBLY FOR AN ENGINE

(71) Applicant: Caterpillar Inc., Peoria, IL (US)

(72) Inventors: Andrew J. Loetz, West Lafayette, IN (US); Robert J. Maxson, Lafayette, IN (US); Joel D. Hiltner, Bellingham, WA (US)

(73) Assignee: Caterpillar Inc., Peoria, IL (US)

(21) Appl. No.: 14/929,438

(22) Filed: Nov. 2, 2015

(51) Int. Cl. F02B 19/10

(52) U.S. Cl. CPC F02B 19/1052; F02B 19/1038

(57) ABSTRACT

A prechamber assembly for an engine is disclosed. The prechamber assembly includes an air-fuel chamber and a prechamber in fluid communication with the air-fuel chamber via a conduit. The conduit includes a first end disposed in the air-fuel chamber and a second end disposed in the prechamber to allow premixed air-fuel mixture to flow from the air-fuel chamber to the prechamber. The prechamber is to receive a lean air-fuel mixture during a compression stroke of the engine. Further, the prechamber assembly also includes a valve disposed at the first end of the conduit, the valve configured to allow the premixed air-fuel mixture to flow from the air-fuel chamber to the prechamber. The premixed air-fuel mixture entering the prechamber mixes with the lean air-fuel mixture to form a stoichiometric ratio of a rich air-fuel mixture.

### TECHNICAL FIELD

The present disclosure relates to an engine, and more particularly to a prechamber assembly for the engine.

### BACKGROUND

Generally, internal combustion engines require fuel to be injected at a particular location. Based on the location at which fuel is injected in an engine, mode of injection is classified as direct injection or indirect injection. In case of direct injection, the fuel is injected directly into the combustion chamber of the engine, and in the case of indirect injection, the fuel is injected at a region outside the combustion chamber of the engine.

However, in order to improve utilization of fuel, an auxiliary chamber, generally referred to as a pre-combustion chamber or a prechamber, is provided in a cylinder head of the engine. The prechamber is coupled to the cylinder head in a manner, such that the prechamber is in fluid communication with the combustion chamber of the engine. Accordingly, in the case of indirect injection, a fuel injector sprays fuel into the prechamber, where the fuel mixes with the air to form the air-fuel mixture. Further, an ignition initiation device, such as a spark plug or a glow plug, is also disposed in the prechamber to initiate the combustion of the air-fuel mixture in the prechamber. As such, the combustion initiates in the prechamber and subsequently proceeds to the combustion chamber. Therefore, volume of the prechamber adds to the volume of the combustion chamber, thereby providing a large volume for the combustion of the air-fuel mixture. However, in order to minimize the amount of particulate matter in exhaust from the engine, it should be ensured that all fuel present in the air-fuel mixture is combusted. Accordingly, the amount of fuel supplied into the prechamber may need to be monitored and controlled.

U.S. Pat. No. 9,004,042 B2 ('042 patent) describes a prechamber of an engine. In particular, the '042 patent describes a method and apparatus for achieving high power flame jets while reducing quenching and auto-ignition in prechamber spark plugs for gas engines. Further, the '042 patent describes that a prechamber spark plug may have a prechamber having a pre-determined aspect ratio and hole pattern to achieve particular combustion performance characteristics. The aspect ratio and the hole pattern may induce a rotational flow of air-fuel in-filling streams inside the prechamber. However, the method and apparatus of the '042 patent are silent on controlling the amount of fuel that is supplied into the prechamber.

### SUMMARY OF THE DISCLOSURE

According to an aspect of the present disclosure, a prechamber assembly for an engine is described. The prechamber assembly includes an air-fuel chamber and a prechamber in fluid communication with the air-fuel chamber via a conduit. The conduit includes a first end disposed in the air-fuel chamber and a second end disposed in the prechamber to allow premixed air-fuel mixture to flow from the air-fuel chamber to the prechamber. The prechamber is configured to receive a lean air-fuel mixture during a compression stroke of the engine. Further, the prechamber assembly includes a valve disposed at the first end of the conduit, the valve configured to allow flow of the premixed air-fuel mixture from the air-fuel chamber to the prechamber during an intake stroke of the engine, where the intake stroke is prior to the compression stroke during operation of the engine. The premixed air-fuel mixture entering the prechamber mixes with the lean air-fuel mixture to form a stoichiometric ratio of rich air-fuel mixture.

Other features and aspects of this disclosure will be apparent from the following description and the accompanying drawings.

### BRIEF DESCRIPTION OF THE DRAWINGS

FIG. 1 shows a cross-section of a cylinder head of an engine equipped with a prechamber assembly, according to one embodiment of the present disclosure; and

FIG. 2 shows an enlarged view of the prechamber assembly of FIG. 1, according to one embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

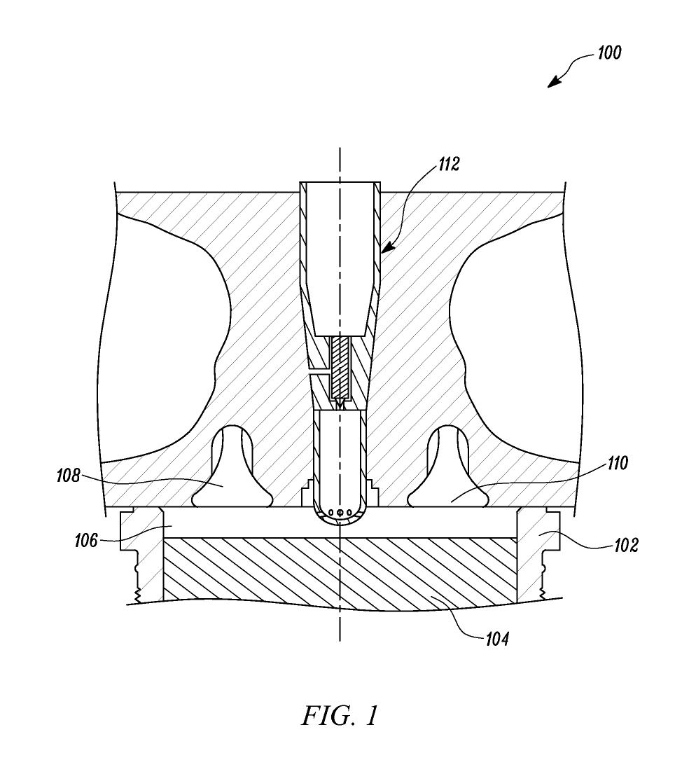

FIG. 1 shows a cross-section of a cylinder head 100 of an engine, according to one embodiment of the present disclosure. The engine may embody a compression ignition engine, a spark-ignition engine, or any type of combustion engine known to one skilled in the art. The engine may be used in various applications such as, but not limited to, transportation, for example, in off-highway trucks, in earth-moving machines; or for power generation, for example, when coupled to a generator set; or to drive turbo-machines and/or other equipment such as, pumps, compressors, and other devices known in the art.

The engine includes a cylinder 102 and a piston 104 capable of reciprocating in the cylinder 102. Typically, the piston 104 reciprocates from a bottom dead center (BDC) to a top dead center (TDC) in multiple cycles. The volume between the TDC and the BDC defines a swept volume, where the swept volume is indicative of a volume available for a combusted charge to occupy. The phrase charge herein may be understood either as air or a mixture of air and fuel. As illustrated in FIG. 1, a head portion of the piston 104 is, generally, provided with a concave region. Accordingly, when the piston 104 is at the TDC, volume available between the head portion of the piston 104 and an inner portion of the cylinder head 100, inclusive of the concave portion in the piston 104, functions as a combustion chamber 106. In an example, the piston 104 may include one or more depressions to further add to the volume of the combustion chamber 106.

For the purpose of introducing the charge into the cylinder 102, the cylinder head 100 is equipped with an inlet valve 108. The cylinder head 100 also includes an inlet port (not shown) that cooperates with the inlet valve 108 to allow the charge to be introduced into the cylinder 102. Once the charge is combusted in the combustion chamber 106, the products of the combustion are forced out of the cylinder 102, by the reciprocating movement of the piston 104, with the aid of an exhaust valve 110.

Further, according to an aspect of the present disclosure, the cylinder head 100 is equipped with a prechamber assembly 112. The prechamber assembly 112 may be understood as an auxiliary device that accommodates a secondary chamber, and being provided in the cylinder head 100 to increase the volume of the combustion chamber 106. The combustion chamber 106 is formed as a small and temporary chamber within the cylinder 102. More often, a combustion initiation device, such as a spark plug or a fuel injector, disposed in the combustion chamber 106 may also occupy a small volume in the combustion chamber 106. In such cases, the prechamber assembly 112 aids in increase in volume of the combustion chamber 106, whilst accommodating the combustion initiation device. In addition, the amount of charge that is supplied into the combustion chamber 106 may need to be calibrated based on the volume available in the combustion chamber 106 to combust the charge. The manner in which the prechamber assembly 112 of the present disclosure aids in controlling the supplying of charge, such as the fuel, would be described in the following paragraphs.

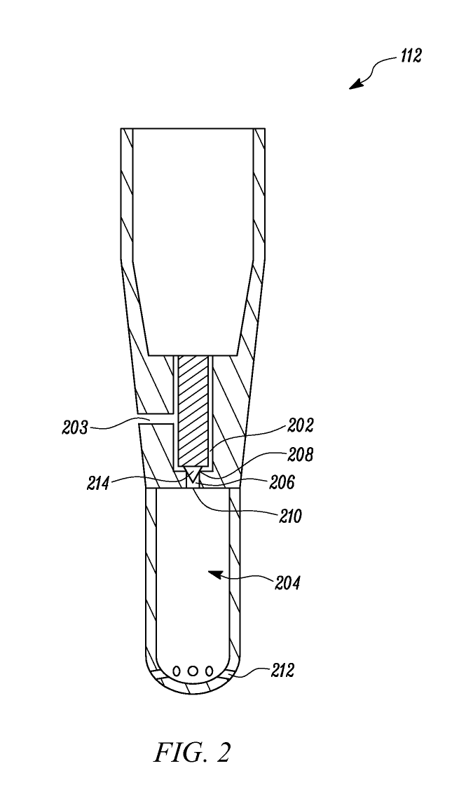

FIG. 2 illustrates an enlarged view of the prechamber assembly 112, in accordance with an embodiment of the present disclosure. The prechamber assembly 112 includes an air-fuel chamber 202 and a prechamber 204 in fluid communication with the air-fuel chamber 202 via a conduit 206. In one example, the prechamber assembly 112 may be formed as an inbuilt device with the cylinder head 100. In another example, the prechamber assembly 112 may be a separate device that can be coupled to the cylinder head 100. The prechamber assembly 112 may, but not limiting to, be fastened to the cylinder head 100. It will be appreciated that the prechamber assembly 112 may be mounted on the cylinder head 100 by any other manner known to the person skilled in the art.

Further, the prechamber assembly 112 may be adapted to support few auxiliary devices. For instance, the wall of the air-fuel chamber 202 may be provided with a channel 203 to receive fuel from a fuel injector (not shown). The manner of fuel injection may either be mechanical injection or electronic injection. It will be understood by a person skilled in the art that the fuel injection may be assisted by fuel pump, fuel accumulator, fuel filter, and a fuel distributor, that are not shown in this disclosure. Accordingly, the prechamber assembly 112 may be coupled to one or more of these devices and, the fuel injector may atomize the fuel and thereafter supply it into the air-fuel chamber 202. The fuel supplied into the air-fuel chamber 202 can be mixed with air to form a premixed air-fuel mixture in the air-fuel chamber 202. Alternatively, a premixed air-fuel mixture is supplied into the air-fuel chamber 202.

Further, the conduit 206 connecting the air-fuel chamber 202 with the prechamber 204, has a first end 208 and a second end 210. The first end 208 of the conduit 206 is disposed in the air-fuel chamber 202 and the second end 210 of the conduit 206 is disposed in the prechamber 204. Such an arrangement allows the premixed air-fuel mixture to flow from the air-fuel chamber 202 to the prechamber 204. The configuration of the conduit 206, such as the diameter and length, may be predetermined to allow a controlled flow of the premixed air-fuel mixture from the air-fuel chamber 202 to the prechamber 204.

The prechamber 204, in addition to receiving the premixed air-fuel mixture from the air-fuel chamber 202, is configured to receive either air or a lean air-fuel mixture during a compression stroke of the piston 104. For the purpose of description, it is considered that the prechamber 204 receives the lean air-fuel mixture from the combustion chamber 106. The lean air-fuel mixture may be understood as a mixture that includes higher stoichiometric amount of air compared to stoichiometric amount of fuel. Accordingly, a stoichiometric ratio of lean air-fuel mixture would have a value greater than one. For the purpose of receiving the lean air-fuel mixture, multiple ports 212 may be provided at a bottom portion of the prechamber 204. In other words, the ports 212 may be formed in the wall of the prechamber 204 at a bottom portion of the prechamber assembly 112. During the compression stroke, the piston 104 moves from the BDC to the TDC. Accordingly, the lean air-fuel mixture drawn into the cylinder 102 in a prior suction stroke is forced into the prechamber 204 through the ports 212, by the piston 104 during the movement from the BDC to the TDC.

The prechamber assembly 112 further includes a valve 214 disposed at the first end 208 of the conduit 206. In one example, the valve 214 may embody, but is not limited to, a ball valve and a plate valve. It will be understood that the ball valve and the plate valve may be modified in their construction to suit the requirement of the prechamber assembly 112, albeit with a few variations as would be known to the person skilled in the art.

Various embodiments disclosed herein are to be taken in the illustrative and explanatory sense, and should in no way be construed as limiting of the present disclosure.

### INDUSTRIAL APPLICABILITY

The present subject matter describes the prechamber assembly 112. As described earlier, the prechamber 204 is configured to receive the lean air-fuel mixture from the combustion chamber 106 during the compression stroke. Due to the compression stroke and owing to a substantially small cross-section of the ports 212, the lean air-fuel mixture entering the prechamber 204 from the combustion chamber 106 may be associated with a substantially high pressure. Moreover, all the lean air-fuel mixture from the combustion chamber 106 does not enter the prechamber 204 due to the substantially small cross-section of the ports 212. As such, a minimal amount of the lean air-fuel mixture may be forced through the ports 212 due to the movement of the piston 104 from the BDC to the TDC.

In operation, the premixed air-fuel mixture admitted into the air-fuel chamber 202 from the channel 203 and the pressure of the lean air-fuel mixture entering the prechamber 204 causes the valve 214 to be displaced from its rest position. In other words, the lean air-fuel mixture entering the prechamber 204 also moves through the conduit 206 and displaces the valve 214. Accordingly, due to the displacement of the valve 214, the first end 208 of the conduit 206 allows the premixed air-fuel mixture to pass through the conduit 206 and into the prechamber 204.

Further, the premixed air-fuel mixture entering the prechamber 204 from the air-fuel chamber 202 mixes with the lean air-fuel mixture to form a stoichiometric ratio of a rich air-fuel mixture. The rich air-fuel mixture may be understood as a mixture of air and fuel, where a stoichiometric amount of fuel in the mixture is greater than the stoichiometric amount of air in the mixture. Accordingly, the stoichiometric ratio of rich air-fuel mixture would have a value less than one. While the premixed air-fuel mixture entering the prechamber 204 mixes with the lean air-fuel mixture already present in the prechamber 204, more lean air-fuel mixture enters the prechamber 204 till the end of the compression stroke. The pressure of the additional lean air-fuel mixture entering the prechamber 204 assists in mixing of the fuel with the lean air-fuel mixture to form the stoichiometric ratio of a rich air-fuel mixture. As such, a homogeneous rich mixture of air and fuel may be formed in the prechamber 204.

A few crank angle degrees before the end of the compression stroke, the rich air-fuel mixture may be combusted in the prechamber 204. For the purpose of initiating the combustion, the prechamber 204 may include the combustion initiating device (not shown), such as a spark plug or a glow plug or a fuel injector in case of diesel engines. As soon as the combustion initiating device is operated, the rich air-fuel mixture may be combusted in the prechamber 204. Owing to the volume of the prechamber 204, the rich air-fuel mixture may be completely combusted in the prechamber 204. As such, no traces of fuel may be left in the prechamber 204 prior to each subsequent intake stroke. Therefore, the prechamber assembly 112 of the present disclosure overcomes problems related to prechamber-scavenging. Furthermore, based on the operation of the engine, stoichiometric ratio of the air-fuel mixture drawn into the cylinder 102 may be varied. For example, during idle running condition of the engine, the amount of fuel in the mixture of air and fuel may be decreased from a normal value, thereby increasing a leanness of the mixture. In another example, during high load conditions, a relatively rich air-fuel mixture may be drawn into the cylinder 102. In such conditions, the premixed air-fuel mixture entering the prechamber 204 mixes with the lean air-fuel mixture present in the prechamber 204, thereby varying the stoichiometric ratio of the air-fuel mixture in the prechamber 204. Therefore, the present disclosure also allows varying the stoichiometric ratio of the mixture of air and fuel in the prechamber 204, with the aid of the valve 214.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A prechamber assembly for an engine, the prechamber assembly comprising:
an air-fuel chamber; and
a prechamber in fluid communication with the air-fuel chamber via a conduit, the conduit comprising:
a first end disposed in the air-fuel chamber, and
a second end disposed in the prechamber to allow premixed air-fuel mixture to flow from the air-fuel chamber to the prechamber, wherein the prechamber is configured to receive a lean air-fuel mixture during a compression stroke of the engine; and
a valve disposed at the first end of the conduit, the valve configured to allow flow of the premixed air-fuel mixture from the air-fuel chamber to the prechamber during an intake stroke of the engine, the intake stroke being prior to the compression stroke during operation of the engine, wherein the premixed air-fuel mixture entering the prechamber mixes with the lean air-fuel mixture to form a stoichiometric ratio of a rich air-fuel mixture.
